(19) United States
(12) Patent Application Publication
(10) Pub. No.: US 2009/0048053 A1
(43) Pub. Date: Feb. 19, 2009

(54) AUXILIARY TRANSMISSION FOR A CONTINOUSLY VARIABLE TRANSMISSION WITH ACTIVE SPEED CONTROL

(76) Inventors: Rex LeRoy Ruppert, Benson, MN (US); Peter H. Kennedy, Murdock, MN (US)

Correspondence Address: CNH AMERICA LLC, INTELLECTUAL PROPERTY LAW DEPARTMENT, 700 STATE STREET, RACINE, WI, 53404, US

(21) Appl. No.: 11/840,001

(22) Filed: Aug. 16, 2007

(51) Int. Cl. B60W 10/02

(52) U.S. Cl. 475/211

(57) ABSTRACT

An auxiliary transmission assembly includes a variable ratio gear assembly that is connected between an engine and the primary transmission of a motor vehicle, and an external input device to form a continuously variable transmission for the vehicle. The external input device is operably engaged with the output of the variable ratio gear assembly and can alter the speed of the output independently of the input to the gear assembly from the engine. The amount of variance provided by the external input device is determined by a controller that senses the change in load on the vehicle engine and operates the external input device to maintain the speed of the vehicle in accordance with a user input for the desired speed.

### FIELD OF THE INVENTION

The invention relates to a continuously variable transmission for a motor vehicle that includes a primary transmission and an auxiliary transmission capable of actively altering the power input to the primary transmission from the engine of the motor vehicle to control the speed of the vehicle.

### BACKGROUND OF THE INVENTION

Both hydrostatic transmissions and geared transmissions are used in agricultural and construction equipment to transmit power from power sources, such as internal combustion engines to equipment for accomplishing a desired task. For example, transmissions are used to properly transmit power to the wheels of a vehicle, or to a vehicle implement. Two important considerations in selecting transmissions are their efficiency and range of input and output speed variability. In general, hydrostatic transmissions provide extremely high-speed variability between the input and output, but are less efficient than geared transmissions. However, regardless of what type of transmission is utilized, there is a need for a transmission for use with agricultural equipment that will provide a constant horsepower with the ability to change speed and torque in a seamless manner, in other words, “continuously variable”.

In the tractor field, transmissions are known in which a continuous control of speed is obtained, said transmissions being referred to as variable-speed drives or continuously variable transmissions (CVTs). In other words, in these transmissions the speed of the motor vehicle can be regulated, without any discontinuity, over the entire the range from the maximum speed of forward movement to the maximum speed of backward movement or maximum speed in reverse.

One example of a transmission construction that accomplishes this is disclosed in Weeramantry U.S. Pat. No. 6,852,056, which is incorporated by reference herein in its entirety. In this patent, a hydro-mechanical transmission is connected to both a primary power source, such as a vehicle engine, and a secondary power source formed of a hydrostatic power unit. The output of both the primary and secondary power sources is directed through a compound planetary gear unit to supply power to a load connected to the transmission in a continuously variable manner.

Alternatively, there are known solutions for providing a smoothly variable transmission which the CVT comprises a first mechanical device with fixed transmission ratio and a second mechanical device with variable transmission ratio. An example of this type of transmission is disclosed in Benassi, et al. U.S. Pat. No. 6,913,555, which is incorporated herein by reference in its entirety. In this transmission construction, to allow the output of the first device to function as the input for the second device, set between the first device and the second device is an epicyclic gear train. The epicyclic gear train enables the variable transmission to interact with the output of the fixed transmission and vary the overall output from the fixed and variable transmissions to act on the load coupled to the CVT, e.g., to drive the vehicle.

However, in the cases of both a single transmission CVT and a CVT including fixed and variable transmissions therein, the constructions of these transmissions are highly complex, due to the number of components necessary to allow the elements of the CVT assemblies to interact with one another in the desired manner. Further, while automatic shifting between the gears of the transmission is available in many of these types of transmissions, they do not provide any active control the speed of the vehicle in a smooth and “stepless” manner utilizing the CVT.

A need has thus arisen to provide an auxiliary transmission assembly for use in constructing a CVT that eliminates a number of the components previously required to construct a CVT, such that the auxiliary transmission assembly can be utilized with both new and existing motor vehicles. The need has also arisen to provide an auxiliary transmission assembly for use in a CVT that provides the same automatic, smoothly variable transmission of power from the engine to the load connected to the engine via the CVT, as in prior art CVTs, but that also enables the auxiliary transmission to actively control the operational speed of the vehicle based upon input from the operator of the vehicle. The need therefore has arisen to provide a simplified, reliable, durable, and efficient auxiliary transmission assembly that can be originally assembled or retrofit onto an existing motor vehicle to form a CVT, and that enables operator input to be used by the auxiliary transmission to actively control the speed of operation of the vehicle in a “stepless” manner.

### SUMMARY OF THE INVENTION

The present invention provides an auxiliary transmission device for a CVT assembly and a CVT assembly including the auxiliary transmission of the present invention. The auxiliary transmission device is formed with a planetary gear unit that is positioned between the drive shaft from the engine and the primary transmission for the motor vehicle. The input for the planetary gear system is directly connected to the crankshaft of the engine. An external input device is connected to the planetary gear unit and operates to actively vary the operating speed of the planetary gear unit, such as to speed up or slow down the output from the planetary gear system. By actively affecting the speed of the output of the planetary gear system, the external input can cause the motor vehicle to operate at a speed above the normal range for a given primary transmission gear. The power assistance provided by the external input through the auxiliary planetary transmission gear unit enables the primary transmission to shift into or repeatedly between different gears in response to sensed changes in the load exerted on the engine without any loss of speed. This is because the external input maintains the desired speed for the motor vehicle by actively assisting the input power to the transmission without changing the output from the motor.

Furthermore, the present invention provides a controller operably connected to the auxiliary transmission that can be utilized by the operator of the motor vehicle to set a desired ground speed for the motor vehicle. As the load on the vehicle changes, such as by reaching an incline or decline in the road, the controller will vary the amount of power supplied by the external input device (engine) through the auxiliary transmission to maintain the speed of the motor vehicle at the selected level, even when the primary transmission shifts gears in response to the change in the load exerted on the engine.

Other objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 schematically illustrates a side elevation view of a first embodiment of an auxiliary transmission assembly constructed in accordance with the present invention.

FIG. 2 schematically illustrates a side elevation view of a second embodiment of an auxiliary transmission assembly constructed in accordance with the present invention.

FIG. 3 schematically illustrates a side elevation view of a third embodiment of an auxiliary transmission assembly constructed in accordance with the present invention.

FIG. 4 schematically illustrates a side elevation view of a fourth embodiment of an auxiliary transmission assembly constructed in accordance with the present invention.

FIG. 5 schematically illustrates a side elevation view of a fifth embodiment of an auxiliary transmission assembly constructed in accordance with the present invention.

FIG. 6 schematically illustrates a side elevation view of a sixth embodiment of an auxiliary transmission assembly constructed in accordance with the present invention.

### DETAILED DESCRIPTION OF THE PREFERRED EMBODIMENTS

A wide variety of auxiliary transmission assemblies and corresponding CVT constructions could be constructed in accordance with the invention defined by the claims. Hence, while preferred embodiments of the invention will now be described with reference to a ladder assembly constructed to be secured to a motorized implement, it should be understood that the invention is in no way so limited.

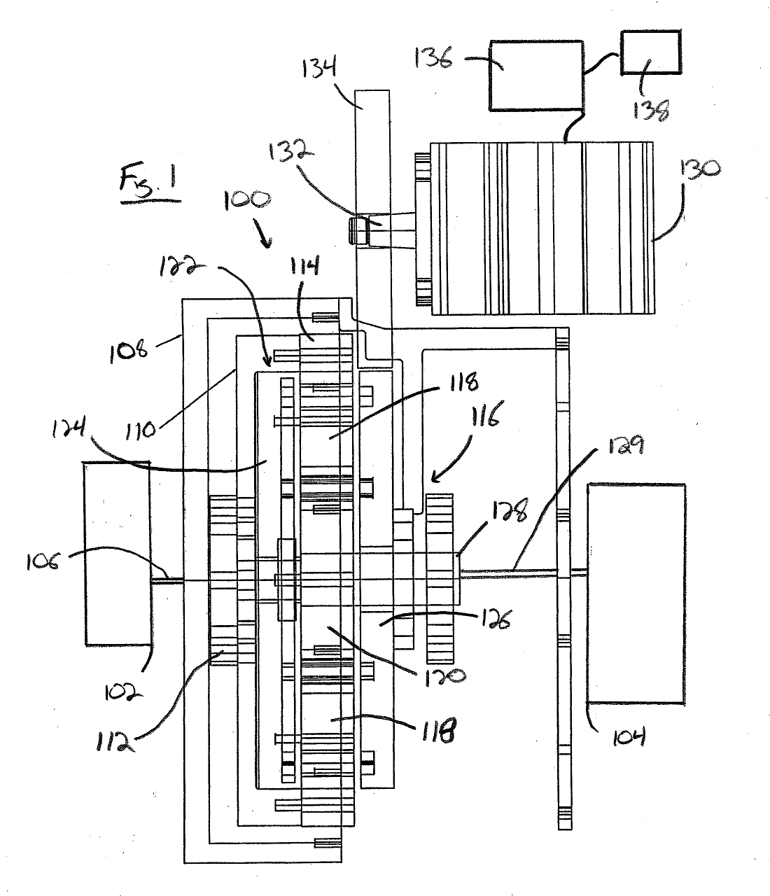

FIG. 1 illustrates a first embodiment of an auxiliary transmission 100 formed in accordance with present invention. The auxiliary transmission 100 is positioned between the engine 102 and the primary transmission 104 for the motor vehicle (not shown). Preferably the primary transmission 104 is a conventional automatic or power shift transmission as is known in the art.

The auxiliary transmission 100 includes a housing 108 that is secured to each of the engine 102 and the transmission 104 in any suitable manner, such as by standard housing mounts (not shown). Within the housing 108 is disposed a flywheel 110 that is operably connected to the output or crankshaft 106 of the engine 102 to rotate in conjunction therewith, such as by a suitable coupling 112. The flywheel 110 is connected opposite the coupling 112 to a ring gear 114 of a planetary gear unit 116. The planetary gear unit 116 is also disposed within the housing 108 and includes the ring gear 114, a number of planetary gears 118 engaged with the interior of the ring gear 114, and a sun gear 120 disposed concentrically within the ring gear 114 and engaged with the planetary gears 118 opposite the ring gear 114. The planetary gears 118 are held between the ring gear 114 and the sun gear 120 by a carrier 122 formed a first portion 124 disposed between the flywheel 110 and the ring gear 114, a second portion 126 spaced from the sun gear 120 opposite the first portion 124, and gear shafts (not shown) fixed at each end to the first portion 124 and second portion 126 and about which the planetary gears 118 are rotatably mounted. Both the first portion 124 and the second portion 126 of the carrier 122 are rotatably mounted about the shaft 128 to which the sun gear 120 is mounted, such that the carrier 122 and the planetary gears 118 rotatably mounted thereto can move with respect to each of the ring gear 114 and the sun gear 120. Further, the shaft 128 on which the sun gear 120 is disposed is connected to, or optionally functions as, the output shaft 129 for the planetary gear unit 116, such that this shaft 128 is operably connected to the primary transmission 104 opposite the sun gear 120.

The auxiliary transmission 100 also includes and external input mechanism 130 located adjacent the housing 108. The external input 130 includes an output shaft 132 that is driven by the external input 130 and to which is secured an input gear 134 opposite the external input 130. The input gear 134 is disposed vertically off of the shaft 132 and engages the second portion 126 of the planetary gear carrier 122, such that rotation of the input gear 134 by the external input 130 causes the carrier 122 to rotate at a speed faster than is achievable solely due to the input power provided by the engine 102. The external input 130 can take any suitable form, such as an electric motor or a hydrostatic motor, among other potential devices, and can draw its operational power from the engine 102 or from another source on the vehicle. The operation of the external input device 130 is capable of varying the speed or rotation of the planetary gear carrier 122 by ±4000 rpm, with a corresponding affect on the speed of the primary transmission 104, all without affecting the rotations per minute (rpm) of the drive shaft of the engine 102.

The level of operation of the external input 130, and the consequent change in rpm transmitted to the primary transmission 104, can be controlled by the use of a suitable controller 136, such as a potentiometer or CPU, that is operably connected to the external input 130, and includes a suitable user input 138. As such, when the engine 102 is in operation, the operator of the vehicle runs the vehicle up to the gear in the primary transmission 104 most appropriate for the desired speed of the vehicle. The operator can then adjust the setting of the controller 136 until the actual speed of the vehicle matches the desired speed as a result of the external input 130 affecting, i.e., increasing or decreasing, the rpm of the primary transmission 104, without any corresponding change to the rpm output of the engine 102. Further, the controller 136 can be designed in a manner that enables it to operate the external input device 130 in a manner that compensates for changes in the load acting on the engine 102 that are sensed by the controller 136. For example, the controller 136, in response to a sensed increase in the load on the engine 102, can increase the speed of the external input 130 to compensate for the additional rpm required to maintain the vehicle at the desired speed within the selected primary transmission gear. Conversely, if the controller 136 were to sense a decrease in the load on the engine 102, the controller 136 could cause the external input 130 to reduce the amount of rpm assistance provided into the transmission 104, or could even cause the external input 130 to reduce the rpm coming out of the engine 102 through the auxiliary transmission 100 by rotating the input gear 134 in a manner that reduces the overall output rpm from the auxiliary transmission 100 to a level below that of the engine crankshaft. In addition, in a situation where the desired speed for the vehicle is set around the upper limit of a gear of the primary transmission 104, the controller 136 can operate the external input 130 in a manner that compensates for the increase or decrease in rpm output from the engine 102 as a result of the automatic shifting of the transmission 104 in response to increases or decreases in the load on the engine 102 sensed by the controller 136. Thus, the controller 136 can be configured to automatically vary the operation of the external input device 130 to optimize shifting and to provide a “stepless” gear shifting feel for the motor vehicle.

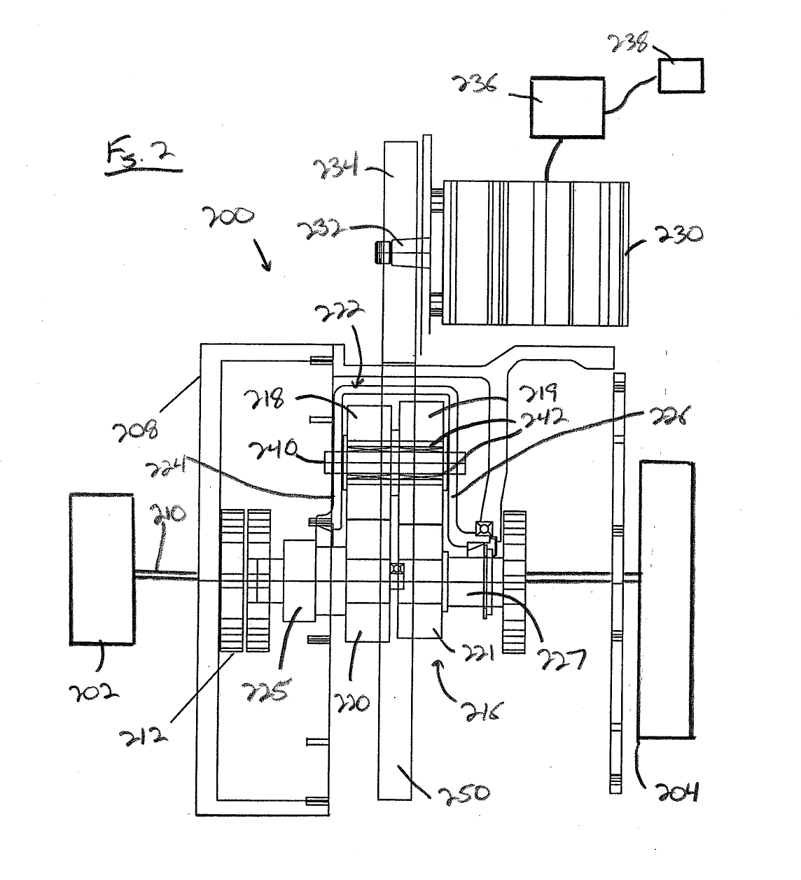

Referring now to FIGS. 2-6, some alternative embodiments for the auxiliary transmission 100 are illustrated that do not include a planetary gear unit having a ring gear. In each of these embodiments, the auxiliary transmission 200 includes a housing 208 that encloses a modified double planetary gear unit 216 that has a planetary gear sets 218 and 219, and dual sun gears 220 and 221. The planetary gear sets 218 and 219 are each rotatably mounted within a planetary gear carrier 222 (of which only the upper half is illustrated in FIGS. 2-5) that includes a first portion 224 rotatably mounted around the input shaft 225 for the sun gear 220, which is operably connected to the crankshaft 210 of the engine 202 via a suitable coupling 212, and a second portion that is rotatably mounted around an output shaft 227 for the sun gear 221 that is operably connected to the primary transmission 204. Preferably, the first portion 224 and the second portion 226 are integrally formed with one another, but the portions 224 and 226 can be formed separately and later secured to one another top form the carrier 222. The planetary gear sets 218 and 219 are also preferably integrally formed with one another, and are held within the carrier 222 by a shaft 240 fixed to the carrier 222 at each end. The planetary gear sets 218 and 219 are supported on the shaft 240 by bearings 242, such that the gear sets 218 and 219 can rotate freely about the shafts 240. Each gear in the planetary gear set 218 and 219 has a specified diameter that corresponds to the diameter and the associated gear ratio of the adjacent sun gear 220 and 221, respectively, to enable the rotation of the engine output shaft to be transmitted through the input shaft 225 and sun gear 220 to the planetary gear set 218, and from the planetary gear set 219 to the sun gear 221 and through the output shaft 227 for direction to the primary transmission 204.

Each embodiment for the auxiliary transmission 200 in FIGS. 2-6 also includes an external input device 230 operably connected to a suitable controller 236 with an operator input 238, and that has an output shaft 232 on which is secured an input gear 234. However, in each embodiment shown in FIGS. 2-6, it is the particular mechanism employed to operably engage the input gear 234 with the carrier 222 that forms the primary differences between the various embodiments.

In FIG. 2, the carrier 222 is formed with an exterior gear 250 disposed around the outer periphery of the carrier 222. This gear 250 is directly engaged with the input gear 234, which is arranged vertically with regard to the carrier 222. This enables the rotation of the input gear 234 by the external input device 230 to speed up the rotation of the gear carrier 222, and consequently the gear sets 218 and 219, and the sun gear 221, to increase the rpm of the shaft 227 connected to the primary transmission 204.

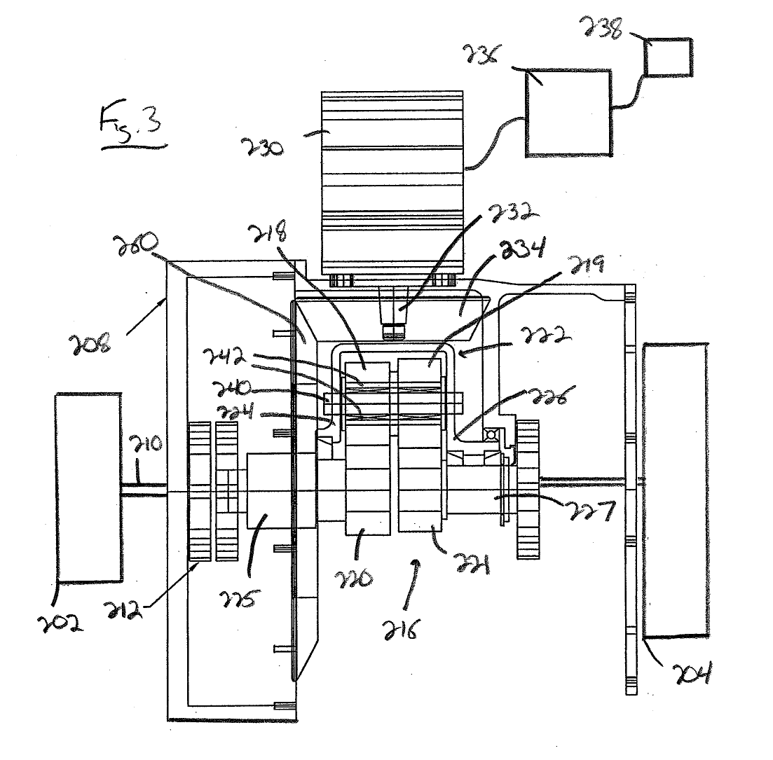

In FIG. 3, a ring and pinion style configuration is illustrated for the auxiliary transmission assembly 200 in which a hypoid or miter style flywheel 260 is fixed to the first portion 224 of the carrier 222 and rotates around the shaft 225. The input gear 234 is also formed to be hypoid or mitered in shape and is shifted to be disposed horizontally, such that the conical edge of the gear 234 can mesh with the conical side of the flywheel 260. Consequently, the external input device 230, which is shifted to a vertical position to accommodate the required position for the gear 234, can supply the added power from the input gear 234 to the flywheel 260 to ultimately increase the speed of the output shaft 227 connected to the primary transmission 204 in the manner described previously.

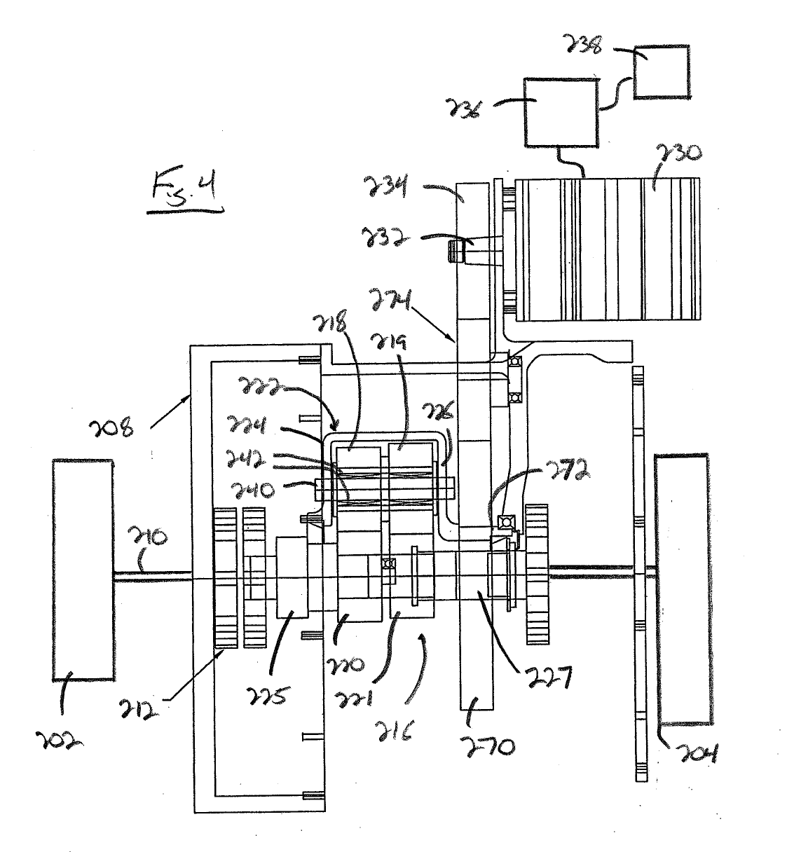

Looking now at FIG. 4, a large gear 270 is fixed in a vertical configuration to an axial extension 272 of the second portion 226 of the carrier 222. The gear 270 is connected to the input gear 234, which is disposed vertically relative to the carrier 222 similarly to the embodiment of FIG. 2, via an idler gear 274 rotatably mounted to the housing 208 and engaged between the input gear 234 and the large gear 270. Thus, power from the external input device 230 can be directed from the input gear 234 through the idler gear 274 to the large gear 270 and carrier 222, to be transmitted to the primary transmission 204 in the manner described previously.

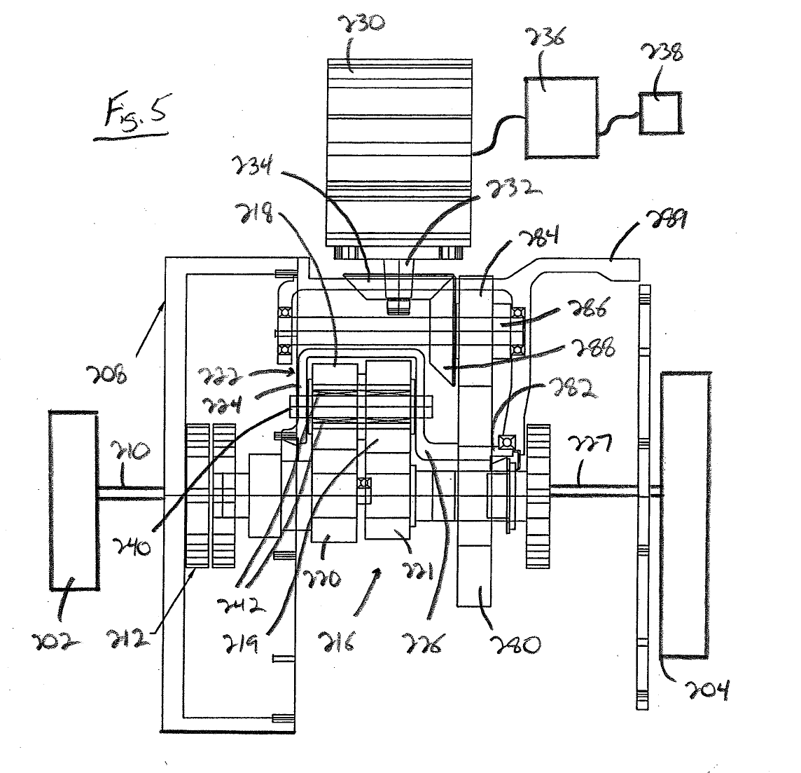

Referring now to FIG. 5, a large gear 280 is fixed in a vertical configuration to an axial extension 282 of the second portion 226 of the carrier 222. The gear 280 is connected to a first idler gear 284 fixed to an idler shaft 286 rotatably mounted at each end to a housing 289 that is secured to the housing 208 and encloses the carrier 222. The idler shaft 286 also includes a second mitered idler gear 288 that is spaced from the first gear and fixed to the shaft 286. This second idler gear 288 is positioned to have its conical edge engage the conical edge of the mitered input gear 234, which is disposed horizontally relative to the carrier 222 similarly to the embodiment of FIG. 3. Thus, power from the external input device 230 is directed from the input gear 234 through the second idler gear 288, idler shaft 286 and first idler gear 284 to the large gear 280 and carrier 222, to be transmitted to the primary transmission 204 in the manner described previously.

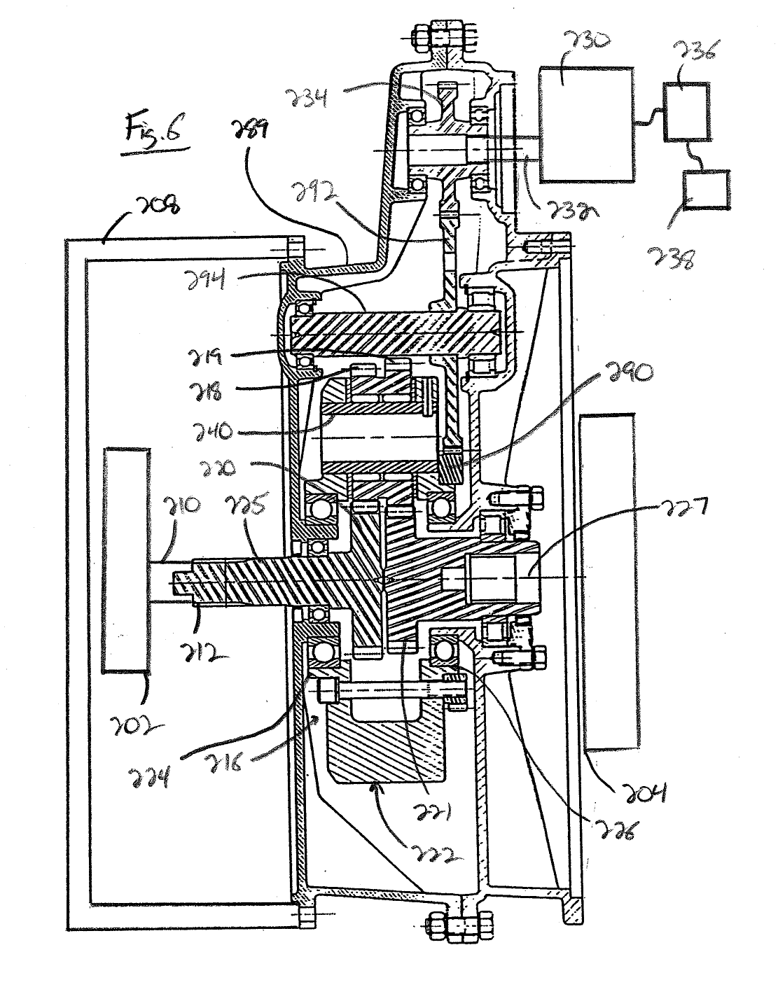

Referring now to FIG. 6, a large gear 290 is fixed to the second portion 226 of the carrier 222, or which can be formed as part of the second portion 226, and is engaged with an idler gear 292 fixedly mounted to an idler shaft 294 that is rotatably mounted at each end to a housing 289. The idler gear 294 is engaged with the input gear 234, which is mounted vertically relative to the carrier 222. Thus, power from the external input device 230 is directed from the input gear 234 through the idler gear 294 to the large gear 290 and carrier 222, to be transmitted to the primary transmission 204 in the manner described previously. Further, in this embodiment, the housing 208 encloses the engine 202, such that the housing 208 can be the body of the vehicle as opposed to another separate structure.

In addition to the above-described embodiments, one skilled in the art will recognize that the auxiliary transmission assembly 100 and/or 200 present invention can include or be used with other suitable structures (not shown) that facilitate the attachment of the auxiliary transmission assembly 100 and/or 200 to motorized implements or other structures, such as various brackets (not shown) or other attachment members (not shown) that can either be formed integrally with the housing 108, or that can be later attached prior to use of the auxiliary transmission assembly 100 and/or 200.

Many changes and modifications could be made to the invention without departing from the spirit thereof. The scope of these changes will become apparent from the appended claims.

We claim:

1. An auxiliary transmission assembly for use in a continuously variable transmission for a motor vehicle, the auxiliary transmission comprising:
a variable ratio gear assembly adapted to be connected to an input from an engine and an output adapted to be connected to a primary transmission assembly; and
an external input device including a drive shaft operably connected to the variable ratio gear assembly, the external input device capable of actively controlling the speed of the output of the variable ratio gear assembly independently of the speed of the input of the variable ratio gear assembly.

2. The auxiliary transmission assembly as recited in claim 1 further comprising a controller operably connected to the external input device and configured to alter the operation of the external input device in response to inputs from an operator of the motor vehicle.

3. The auxiliary transmission assembly as recited in claim 2, wherein the controller includes an operator input mechanism.

4. The auxiliary transmission assembly as recited in claim 1, wherein the variable ratio gear assembly comprises a planetary gear assembly including a ring gear, a plurality of planetary gears disposed within and operably connected to the ring gear, and a sun gear disposed between and engaged by each of the planetary gears, and wherein the input is operably connected to the ring gear and the output is operably connected to the sun gear.

5. The auxiliary transmission assembly as recited in claim 4 wherein the external input device is operably connected to the ring gear.

6. The auxiliary transmission assembly as recited claim 1, wherein the external input device includes an input gear driven by the external input device and engaged with the variable ratio gear assembly.

7. The auxiliary transmission assembly as recited in claim 1, wherein the variable ratio gear assembly comprises a double planetary gear assembly including a first sun gear, a first planetary gear set operably connected to the first sun gear, a second sun gear, a second set of planetary gears operably connected to the second sun gear and to the first set of planetary gears, and a planetary gear carrier disposed around and engaged with the first and second planetary gear sets, wherein the input is operably connected to the first sun gear and the output is operably connected to second sun gear.

8. The auxiliary transmission assembly as recited in claim 7, wherein the external input device is operably connected to the planetary gear carrier.

9. The auxiliary transmission assembly as recited claim 8, wherein a rotational axis of a drive shaft of the external input device is oriented perpendicular to a rotational axis of the planetary gear carrier.

10. The auxiliary transmission assembly as recited claim 9, wherein the drive shaft includes a first mitered gear engaged with a second mitered gear fixed to the planetary gear carrier.

11. The auxiliary transmission assembly as recited claim 8, wherein a rotational axis of the drive shaft of the external input device is oriented parallel to a rotational axis of the planetary gear carrier.

12. The auxiliary transmission as recited in claim 8 further comprising a drive shaft operably connected to the external input device, a drive gear disposed on the drive shaft, and an idler gear engaged between the drive gear and the planetary gear carrier.

13. A continuously variable transmission for use with a motor vehicle, the transmission comprising:
a primary transmission adapted to be connected to a vehicle; and
an auxiliary transmission assembly including a variable ratio gear assembly having an input adapted to be connected to the crankshaft of an engine for the vehicle and an output connected to the primary transmission, and an external input device including a drive shaft operably connected to the variable ratio gear assembly, the external input device capable of actively controlling the speed of the output of the variable ratio gear assembly independently of the speed of the input of the variable ratio gear assembly.

14. The continuously variable transmission assembly as recited in claim 13 wherein the primary transmission is an automatically shifting transmission.

15. The continuously variable transmission as recited in claim 13 wherein the auxiliary transmission assembly further comprises controller operably connected to the external input device and configured to alter the operation of the external input device.

16. The continuously variable transmission as recited in claim 15 wherein in the controller further comprises an operator input device operably connected to the controller.

17. A method of controlling the speed of a motor vehicle, the method comprising the acts of:
providing a continuously variable transmission for use with a motor vehicle, the transmission comprising:
a primary transmission adapted to be connected to a vehicle, and an auxiliary transmission assembly including a variable ratio gear assembly having an input adapted to be connected to the crankshaft of an engine for the vehicle and an output connected to the primary transmission, and an external input device including a drive shaft operably connected to the variable ratio gear assembly, the external input device capable of actively controlling the speed of the output of the variable ratio gear assembly independently of the speed of the input of the variable ratio gear assembly; and
operating the external input device to vary the output speed of the variable ratio gear assembly.

18. The method as recited in claim 17, wherein the act of operating the external input device comprises operating the external input to either increase or decrease the speed of the output of the variable ratio gear assembly relative to the input speed of the variable ratio gear assembly.

19. The method as recited in claim 18, further comprising the act of setting a desired operating speed for the motor vehicle utilizing an operator input device prior to operating the external input device.

20. The method as recited in claim 17, further comprising the act of shifting the operating gear of the primary transmission concurrently with the act of operating the external input device.
